(19) United States
(12) Patent Application Publication
(10) Pub. No.: US 2025/0317921 A1
(43) Pub. Date: Oct. 9, 2025

(54) PARAMETER CONFIGURATION IN WIRELESS COMMUNICATION

(71) Applicant: ZTE CORPORATION, Shenzhen, Guangdong (CN)

(72) Inventors: Jiajun XU, Shenzhen, Guangdong (CN); Hong TANG, Shenzhen, Guangdong (CN); Xiaoying MA, Shenzhen, Guangdong (CN); Jianqiang DAI, Shenzhen, Guangdong (CN); Mengzhu CHEN, Shenzhen, Guangdong (CN); Jun XU, Shenzhen, Guangdong (CN); Bo DAI, Shenzhen, Guangdong (CN)

(21) Appl. No.: 18/864,527

(22) PCT Filed: Jul. 1, 2022
(86) PCT No.: PCT/CN2022/103476

§ 371 Date: Nov. 10, 2024

(51) Int. Cl. H04W 72/11; H04W 72/23

(52) U.S. Cl. CPC H04W 72/11; H04W 72/23

(57) ABSTRACT

Methods and systems for techniques for configuring parameters in wireless communications are disclosed. In an implementation, a method of wireless communication includes receiving, by a wireless device, from a network node, a first signaling including a first information associated with semi-persistent scheduling (SPS) resources for an SPS configuration, and determining, by the wireless device, one or more time domain locations of SPS resources for the SPS configuration based on the first information.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for updating user equipment capability information.

In one aspect, a method of data communication is disclosed. The method includes receiving, by a wireless device, from a network node, a first signaling including a first information associated with semi-persistent scheduling (SPS) resources for an SPS configuration; and determining, by the wireless device, one or more time domain locations of SPS resources for the SPS configuration based on the first information.

In another aspect, a method of data communication is disclosed. The method includes transmitting, by a network node, to a wireless device, a first signaling including a first information associated with semi-persistent scheduling (SPS) resources for an SPS configuration, wherein the first information is used to determine one or more time domain locations of the SPS resources for the SPS configuration.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example of legacy semi-persistent scheduling (SPS)/configured grant (CG) configuration pattern.

FIG. 4 shows an example of N periodicities that are used for configuring SPS resources cyclically.

FIG. 5 shows 3 configurations used for configuring SPS resources carrying traffic with 60 FPS periodicity based on some embodiments of the disclosed technology.

FIG. 6 shows an example of SPS resource locations based on some embodiments of the disclosed technology.

FIG. 7 shows an example of super frame, system frame and slot.

FIG. 8 shows another example of super frame, system frame and slot.

FIG. 9 shows an example of an enlarged super frame.

FIG. 10 shows an example of a process for wireless communication based on some example embodiments of the disclosed technology.

FIG. 11 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

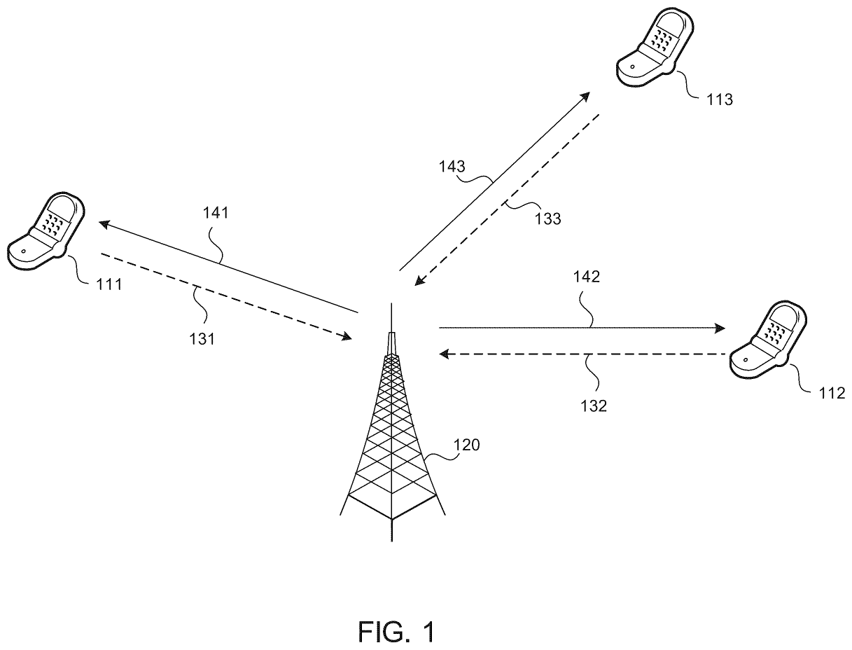

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

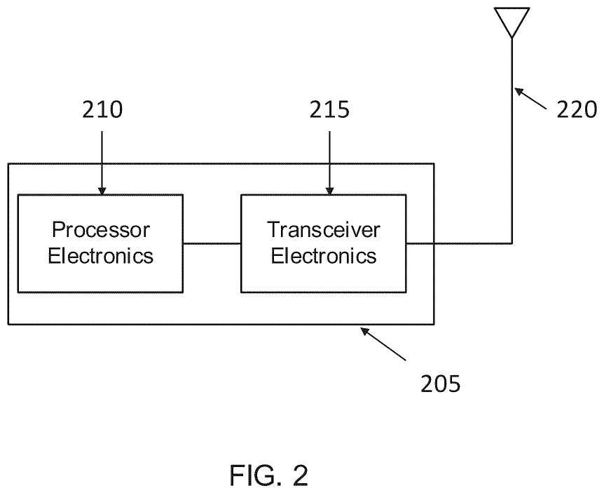

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

In beyond-5G and 6G communication, one of promising services, including, e.g., extended reality, is characterized by periodicity. However, in this kind of service, video streaming is a basic type, whose typical periodicity is 60 frame per second (FPS), 90 FPS 120 FPS, which is a non-integer periodicity in millisecond.

In other implementations, granted transmission, including configured grant (CG) and semi-persistent scheduling (SPS), is capable of conveying periodic data by preconfigured resource without grant request and excessive power consumption. However, the candidate periodicity for configuration is an integer periodicity.

Carrying the video streaming traffic, the current SPS/CG may encounter a misalignment between a preconfigured resource and a packet arrival, which gradually deteriorates with the transmission process and finally results in a large transmission delay.

The disclosed technology can be implemented in some embodiments to provide schemes to align the traffic arrival with non-integer periodicity and SPS/CG resources.

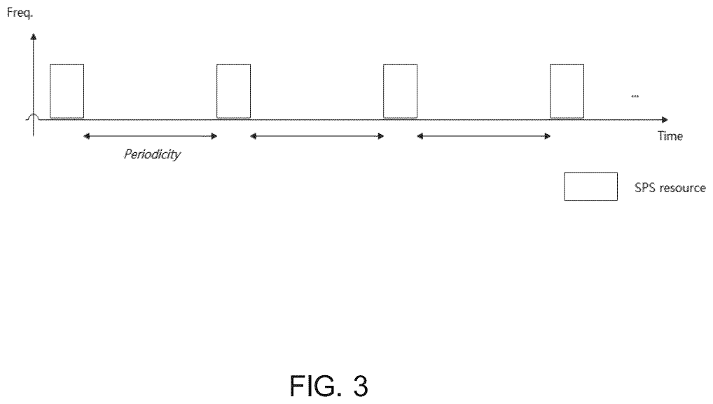

FIG. 3 shows an example of legacy semi-persistent scheduling (SPS)/configured grant (CG) configuration pattern.

In some implementations, SPS resources may include SPS for downlink and CG for uplink.

For the semi-persistent scheduling (SPS) transmission and configured grant (CG) transmission, gNB first transmits a RRC signaling SPS-config and ConfiguredGrantConfig, where periodicity is configured. Then, the resources for SPS/CG derived according to the periodicity parameter.

TABLE 1
SPS-config/ConfiguredGrantConfig

| | |
|---|---|
| SPS-Config ::= | SEQUENCE { |
| periodicity | ENUMERATED {ms10, ms20, ms32, ms40, ms64, ms80, ms128, |

ms160, ms320, ms640, spare6, spare5, spare4, spare3, spare2, spare1},
...
}

| | |
|---|---|
| ConfiguredGrantConfig ::= | SEQUENCE { |

...

| | |
|---|---|
| periodicity | ENUMERATED {sym2, sym7, sym1x14, sym2x14, sym4x14, |

sym5x14, sym8x14, sym10x14, sym16x14, sym20x14, sym32x14, sym40x14, sym64x14, sym80x14,
sym128x14, sym160x14, sym256x14, sym320x14, sym512x14, sym640x14, sym1024x14, sym1280x14,
sym2560x14, sym5120x14, sym6, sym1x12, sym2x12, sym4x12, sym5x12, sym8x12, sym10x12, sym16x12,
sym20x12, sym32x12, sym40x12, sym64x12, sym80x12, sym128x12, sym160x12, sym256x12, sym320x12,
sym512x12, sym640x12, sym1280x12, sym2560x12
},
. . .
}

TABLE 2
Legacy SPS and CG resource calculation

```
  After a downlink assignment is configured for SPS, the MAC entity shall consider sequentially
that the N^{th} downlink assignment occurs in the slot for which:
$( numberOfSlotsPerFrame \times SFN + slot number in the frame ) = \\ [ ( numberOfSlotsPerFrame \times {SFN}_{start time} + {slot}_{start time} ) + N \times periodicity \times numberOfSlotsPerFrame / 10 ] modulo \\ ( 1024 \times numberOfSlotsPerFrame )$
  where SFN_{start time} and slot_{start time} are the SFN and slot, respectively, of the first transmission
of PDSCH where the configured downlink assignment was (re-)initialised.
  After an uplink grant is configured for a configured grant Type 1, the MAC entity shall consider
sequentially that the N^{th} (N >= 0) uplink grant occurs in the symbol for which:
$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N + periodicity ) \text{} modulo ( 1024 \times numberOfSlotsPerFrame \times numberOfSymbolsPerSlot ) .$
  After an uplink grant is configured for a configured grant Type 2, the MAC entity shall consider
sequentially that the N^{th} (N >= 0) uplink grant occurs in the symbol for which:
$[ ( SFN \times numberOfSlotsPerFrame \times numberOfSymbolsPerSlot ) + ( slot number in the frame \times numberOfSymbolsPerSlot ) + symbol number in the slot ] = [ ( {SFN}_{start time} \times numberOfSlotsPerFrame \times numberOfSymbolsPerSlot + {slot}_{start time} \times numberOfSymbolsPerSlot + {symbol}_{start time} ) + N \times periodicity ] \text{} \text{} modulo ( 1024 \times numberOfSlotsPerFrame \times numberOfSymbolsPerSlot ) .$
```

The mismatch between an SPS/CG configuration and a packet arrival may cause a lot of issues.

Assuming the periodicity is 60 fps, and the packet arrives per 16.666 . . . ms. In some implementations, the resources are always configured along with or after the packet arrival.

If the periodicity of SPS configuration is set to 17 milliseconds, the periodicity is an integer value close to the periodicity of XR traffic. The millisecond values of packet arrivals, SPS PDSCH time locations and the gap between packet arrivals as well as SPS PDSCH locations are shown in Table 3, respectively.

TABLE 3
The millisecond values of packet arrivals, SPS PDSCH time
locations and delay from the 1-st packet to the 8-th packet

| Tx No. | 1st | 2nd | 3rd | 4th | 5th | 6th | 7th | 8th |
|---|---|---|---|---|---|---|---|---|
| Packet Arrival (ms) | 0 | 16.67 | 33.33 | 50.00 | 66.67 | 83.33 | 100 | 116.67 |
| SPS PDSCH TOs | 0 | 17 | 34 | 51 | 68 | 85 | 102 | 119 |
| Tx Delay(ms) | 0 | 0.33 | 0.67 | 1 | 1.33 | 1.67 | 2 | 2.33 |

The above table implies that a transmission delay may increase over time and become unaffordable for systems.

The method for alignment based on some implementations of the disclosed technology may affect the legacy SPS and CG resource calculation. For example, for a downlink, the K-th transmission occasion (or K-th resource) is expressed as:

$${N}_{slot}^{frame} \times {L}_{SFN} + {L}_{slot} = [ ( {N}_{slot}^{frame} \times {S}_{SFN , Start} + {S}_{slot , start} + Δ ) + f ( K , P ) \times {N}_{slot}^{frame} / 10 ] modulo ( 1024 \times {N}_{slot}^{frame} ) \qquad ( Eq . 1 )$$

wherein

$${N}_{slot}^{frame}$$

denotes the number of slots in a system frame, L_{SFN} denotes the identifier number of the system frame, Lₛₗₒₜ denotes the identifier number of the slot in the system frame, S_{SFN,Start} denotes the starting system frame identifier number, S_{slot,Start} denotes the starting slot identifier number in the system frame, and P denotes the periodicity configured in RRC signaling.

For an uplink, the K-th transmission occasion (or K-th resource) of Type-1 CG is expressed as:

$$[ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN} \times {N}_{slot}^{frame} \times {N}_{symbol}^{slot} + {Δ}_{offset} \times {N}_{symbol}^{slot} + S + Δ + f ( K , P ) ] modulo ( 1024 \times {N}_{slot}^{frame} \times {N}_{symbol}^{slot} ) \qquad ( Eq . 2 )$$

wherein Δ_{offset} denotes the offset of SPS resource with respect to L_{SFN} in time domain,

$${N}_{symbol}^{slot}$$

denotes the number of symbols in a slot, and >denotes the starting symbols which is derived from SLIV indication or provided by startSymbol.

While the K-th transmission occasion (or K-th resource) of Type-2 CG is expressed as:

$$[ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN , start} \times {N}_{slot}^{frame} \times {N}_{symbol}^{slot} + {S}_{slot , start} \times {N}_{symbol}^{slot} + {S}_{symbol , start} + Δ + f ( K , P ) ] modulo ( 1024 \times {N}_{slot}^{frame} \times {N}_{symbol}^{slot} ) \qquad ( Eq . 3 )$$

wherein S_{symbol,start} denotes the starting symbol in the slot.

The disclosed technology can be implemented in some embodiments to configure an offset information Δ, a function of periodicity f(*), as well as an offset information and a function of periodicity to align the preconfigured SPS resource and non-integer periodical packet arrival.

In some embodiments, a method includes: configuration; and formula.

In some implementations, SPS can indicate SPS configuration for downlink and/or CG configuration for uplink.

In some implementations, SPS resource can indicate SPS PDSCH for downlink and/or CG PUSCH for uplink

In this disclosure, the issues need to be addressed includes:

The disclosed technology can be implemented in some embodiments to provide (1) interpretation of a first signaling; (2) configuration method for alignment; and (3) formula method for alignment.

The disclosed technology can be implemented in some embodiments to provide a method that include receiving, from a network node, a first signaling including a first information associated with SPS resources for an SPS configuration, and determining slot or symbol locations of SPS resources for the SPS configuration based on the first information by using a configuration method or a formula method as will be discussed below.

In some implementations, the SPS configuration includes one or more SPS resources. Taking FIG. 3 as an example, 4 SPS resources shown in the figure belong to the SPS configuration.

### Interpretation of a First Signaling

In some embodiments of the disclosed technology, the first signaling is a high layer signaling.

In some implementations, the high layer signaling includes at least one of RRC signaling or MAC CE signaling. In one example, the RRC signaling is SPS-config. In another example, the RRC signaling is ConfiguredGrantConfig. In another example, the MAC CE signaling is Configured Grant Confirmation MAC CE. In another example, the MAC CE signaling is Multiple Entry Configured Grant Confirmation MAC CE.

In some embodiments of the disclosed technology, the first signaling is DCI signaling.

In some implementations, the DCI signaling is UE-specific DCI, such as, DCI format 0_0, DCI format 0_1, DCI format 0_2 for uplink transmission, and DCI format 1_0, DCI format 1_1, DCI format 1_2 for downlink transmission.

In some implementations, the DCI signaling is Group-Common DCI, such as, DCI format 2_6, or a new DCI format 2, such as DCI format 2_7, DCI format 2_8 and so on.

In some embodiments of the disclosed technology, the first signaling is RRC signaling and DCI signaling.

In some implementations, the RRC signaling is SPS-config and DCI signaling is DCI format 1_0, DCI format 1_1, or DCI format 1_2.

In some implementations, the RRC signaling is ConfiguredGrantConfig, and DCI signaling is DCI format 0_0, DCI format 0_1, or DCI format 0_2.

In some embodiments of the disclosed technology, the first signaling is MAC CE signaling and DCI signaling.

In some implementations, the MAC CE signaling is Configured Grant Confirmation MAC CE and DCI format 0_0, DCI format 0_1, or DCI format 0_2.

In some implementations, the MAC CE signaling is Multiple Entry Configured Grant Confirmation MAC CE and DCI format 0_0, DCI format 0_1, or DCI format 0_2.

In some embodiments of the disclosed technology, the first signaling includes a first information.

In some implementations, the first information includes a number of SPS configurations.

In some implementations, the first information includes one SPS configuration.

In some implementations, the first information includes a plurality of SPS configurations.

In some implementations, the first information includes one periodicity of SPS resources for one SPS configuration.

In some implementations, the first information includes a plurality of periodicities of SPS resources for one SPS configuration. In one example, the first information includes N periodicities {P₁, . . . , P_{N}} for one SPS configuration.

In some implementations, the first information includes an offset for one SPS configuration.

In some implementations, the first information includes a plurality of offsets for one SPS configuration. In one example, the first information includes M offsets {O₁, . . . , O_{M}} for one SPS configuration.

In some implementations, the first information includes a number of SPS configurations and a plurality of SPS configurations.

In some implementations, the first information includes one periodicity and one offset.

In some implementations, the first information includes one periodicity and a plurality of offsets.

In some implementations, the first information includes a plurality of periodicities and a plurality of offsets.

In some implementations, the first information includes one periodicity, a plurality of offsets and a plurality of SPS configurations.

In some implementations, the first information includes a plurality of periodicities, a plurality of offsets and a plurality of SPS configurations.

In some embodiments of the disclosed technology, the time domain locations include slot locations or symbol locations. In one example, for downlink, the time domain locations are slot locations. In another example, for uplink, the time domain locations are symbol locations.

In some embodiments of the disclosed technology, if a first signaling is DCI signaling, RRC signaling and DCI signaling, as well as MAC CE signaling and DCI signaling, a field of DCI associated with the first information includes at least one of:
(1) hybrid automatic repeat request (HARQ) process number, redundancy version, time domain resource assignment, frequency domain resource assignment, modulation and coding scheme, downlink assignment index, transmission power control (TPC) command for scheduled physical uplink control channel (PUCCH), or virtual resource block (VRB)-to-physical resource block (PRB) mapping if the DCI is DCI format 0_0, DCI format 0_1, DCI format 0_2, DCI format 1_0, DCI format 1_1, DCI format 1_2; or
(2) a specific field associated with the first information if the DCI is DCI format 2.

In some embodiments of the disclosed technology, the length of the field of the DCI associated with the first information is determined by UE capability including at least one of: a maximum number of periodicities, a maximum number of offsets, or a maximum number of SPS configurations.

In some implementations, the length of the field is a maximum number of periodicities, a maximum number of offsets, or a maximum number of SPS configurations.

In some implementations, the length of field is not less than 0 and not larger than a maximum number of periodicities, a maximum number of offsets, or a maximum number of SPS configurations.

In some embodiments of the disclosed technology, a periodicity in the first information includes: a non-integer value or an integer value.

In some implementations, the periodicity is a non-integer that is larger than 0 in millisecond, symbol, or slot.

In some implementations, the periodicity is a float in millisecond or symbol or slot. In one example, if the periodicity is a float, the value of periodicity is: 16.66, 16.67 with 2 decimals remaining in the unit of millisecond, or 16.6, 16.7 with 1 decimal remaining in the unit of millisecond. In another example, if the periodicity is a float, the value of periodicity is: 16.66×14, 16.67×14, 16.66×12, 16.67×12 with 2 decimals remaining in the unit of symbol, or 16.6×14, 16.7×14, 16.6×12, 16.7×12 with 1 decimal remaining in the unit of symbol.

In some implementations, the periodicity is a fraction in millisecond, symbol or slot, wherein a numerator of the fraction includes at least one of: a frame per second (FPS) that indicates a number of frames that appears within a second, wherein a denominator of the fraction includes a high layer parameter, such as time range. The candidate values of FPS at least include 30, 60, 90, 120, while the candidate values of time range at least include 3, 50, 1000. In one example, if the periodicity is a fraction in millisecond, the numerator of the fraction is at least one of: a parameter of SPS-config or frame per second parameter of SPS-config, while the denominator of the fraction is a high layer parameter or a default value. For the traffic with 60 FPS, the periodicity in millisecond is expressed as:

Case 1: The numerator of the fraction is frame per second parameter (60 FPS) of SPS-config, and the denominator of the fraction is a high layer parameter, time range (1000 ms). The non-integer periodicity is determined by both frame per second parameter and time range parameter, i.e., 1000/60.

Case 2: The numerator of the fraction is frame per second parameter (60 FPS) of SPS-config, and the denominator of the fraction is a default value (1000 ms). The non-integer periodicity is determined by frame per second parameter, i.e., 1000/60.

Case 3: The numerator of the fraction is a high layer parameter (3) of SPS-config, and the denominator of the fraction is a high layer parameter (50) of SPS-config. The non-integer periodicity is determined by two high layer parameters, i.e., 50/3.

In another example, if the periodicity is a fraction in symbol, the numerator of the fraction is at least one of: a parameter of ConfiguredGrantconfig or frame per second parameter of ConfiguredGrantconfig, while the denominator of the fraction is a high layer parameter or a default value. For the traffic with 60 FPS, the periodicity in millisecond is expressed as:

Case 1: The numerator of the fraction is frame per second parameter (60 FPS) of ConfiguredGrantconfig, and the denominator of the fraction is a high layer parameter, time range (1000 ms). The non-integer periodicity is determined by both frame per second parameter and time range parameter, i.e., 1000×14/60 or 1000×12/60.

Case 2: The numerator of the fraction is frame per second parameter (60 FPS) of ConfiguredGrantconfig, and the denominator of the fraction is a default value (1000 ms). The non-integer periodicity is determined by frame per second parameter, i.e., 1000×14/60 or 1000×12/60.

Case 3: The numerator of the fraction is a high layer parameter (3) of ConfiguredGrantconfig, and the denominator of the fraction is a high layer parameter (50) of ConfiguredGrantconfig. The non-integer periodicity is determined by two high layer parameters, i.e., 50×14/3 or 50×12/3.

### Configuration Method for Alignment

In some embodiments of the disclosed technology, the time domain locations of R SPS resources are determined based on the first information in order to align with the packet arrival.

In some implementations, the R SPS resources belong to one SPS configuration.

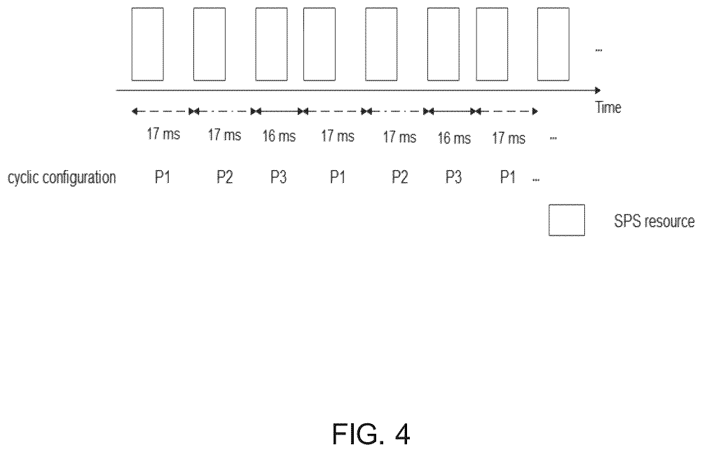

FIG. 4 shows an example of N periodicities that are used for configuring SPS resources cyclically.

In some implementations, when the R SPS resources belong to one SPS configuration, the first information includes N periodicities {P₁, . . . , P_{N}} for configuring the periodicity of R SPS resources, wherein the N periodicities {P₁, . . . , P_{N}} are used for configuring the SPS resource cyclically. In one example, assuming the periodicity of traffic is 60 FPS, implying the packet arrives in each 16.66 . . . ms, the periodicity set is configured to {P=17, P₂₌₁₇, P₃₌₁₆} ms, then the configuration will be as illustrated in FIG. 4.

In some implementations, examples of combinations of N periodicities in the first information include at least one of:
Downlink 60 FPS: {17,17,16} ms, {18, 16, 16} ms, {18, 17, 16} ms, {18, 16, 17} ms;
Downlink 120 FPS: {9, 8, 8, 9, 8, 8} ms, {9,9,8,8,8,8} ms, {9,8,9,8,8,8} ms;
Uplink 60 FPS: {17×14, 17×14, 16×14} symbols, {18×14, 16×14, 16×14} symbols, {18×14, 17×14, 16×14} symbols, {18×14, 16×14, 17×14} symbols; and
Uplink 120 FPS: {9×14, 8×14, 8×14, 9×14, 8×14, 8×14} symbols.

In some implementations, when the R SPS resources belong to one SPS configuration, the first information includes one periodicity and M offsets {O₁, . . . , O_{M}} for configuring the periodicity of R resources, wherein the M offsets {O₁, . . . , O_{M}} are used for configuring SPS resource cyclically. In an example, assuming the periodicity of traffic is 60 FPS and the packet arrives in each 16.66 . . . ms, the first information includes a periodicity P=17 ms and 3 offsets {O₁=0, O₂=0, O₃=−1}, and then the periodicity of the R SPS resources can be derived from (P+Ox), wherein x=1, 2, 3.

In some implementations, examples of combinations of the periodicity and M offsets in the first information include at least one of:
Downlink 60 FPS:
Common periodicity: 16 ms, Offset={1, 1, 0}
Common periodicity: 17 ms, Offset={0, 0, −1}
Downlink 120 FPS:
Common periodicity: 9 ms, Offset={0, −1, −1, 0, −1, −1}, {0,0, −1, −1, −1, −1}
Common periodicity: 8 ms, Offset={1, 0, 0, 1, 0, 0}, {1, 1, 0, 0, 0, 0}
Uplink 60 PFS
Common periodicity: 17×14 symbols, offset={0, 0, −1}
Common periodicity: 16×14 symbols, offset={1, 1, 0}
Uplink 120 FPS:
Common periodicity 9×14 symbols, offset={0, −1, −1, 0, −1, −1}.

In some embodiments of the disclosed technology, the first information is in the first signaling, when the first signaling is RRC signaling.

In some implementations, the first information is in the periodicity parameter periodicity in RRC signaling in TS38.331 V17.0.0.

TABLE 4
Example of RRC signaling:

| | |
|---|---|
| SPS-Config ::= | SEQUENCE { |
| periodicity | ENUMERATED {ms10, ms20, ms32, ms40, ms64, ms80, ms128, ms160, |

ms320, ms640, PeriodSet1, PeriodSet2, PeriodSet3, spare3, spare2, spare1},
...
}

| | |
|---|---|
| ConfiguredGrantConfig ::= | SEQUENCE { |

...

| | |
|---|---|
| periodicity | ENUMERATED {sym2, sym7, sym1x14, sym2x14, sym4x14, sym5x14, |

sym8x14, sym10x14, sym16x14, sym20x14, sym32x14, sym40x14, sym64x14, sym80x14, sym128x14,
sym160x14, sym256x14, sym320x14, sym512x14, sym640x14, sym1024x14, sym1280x14, sym2560x14,
sym5120x14, sym6, sym1x12, sym2x12, sym4x12, sym5x12, sym8x12, sym10x12, sym16x12, sym20x12,
sym32x12, sym40x12, sym64x12, sym80x12, sym128x12, sym160x12, sym256x12, sym320x12, sym512x12,
sym640x12, sym1280x12, sym2560x12, PeriodSet1, PeriodSet2, PeriodSet3
},
...
}
Note:
the parameter with underline is the first information

In some implementations, if the first information is configured, the periodicity parameter periodicity in RRC signaling in TS38.331 V17.0.0 is not configured.

TABLE 5
Example for DL SPS and UL CG:

| | |
|---|---|
| SPS-Config ::= | SEQUENCE { |
| periodicity | ENUMERATED {ms10, ms20, ms32, ms40, ms64, ms80, ms128, |

ms160, ms320, ms640, spare6, spare5, spare4, spare3, spare2, spare1},

| | |
|---|---|
| PeriodicitySet | ENUMERATED {Set1, Set2, Set3, ...} |

}

| | |
|---|---|
| SPS-Config ::= | SEQUENCE { |
| periodicity | ENUMERATED {ms10, ms20, ms32, ms40, ms64, ms80, ms128, |

ms160, ms320, ms640, spare6, spare5, spare4, spare3, spare2, spare1},

| | |
|---|---|
| Periodicity-r18 | ENUMERATED {ms16, ms17, ms18, ...} |
| OffsetSet | ENUMERATED {Set1, Set2, Set3} |

}

| | |
|---|---|
| ConfiguredGrantConfig ::= | SEQUENCE { |

...

| | |
|---|---|
| periodicity | ENUMERATED {sym2, sym7, sym1x14, sym2x14, sym4x14, sym5x14, |

sym8x14, sym10x14, sym16x14, sym20x14, sym32x14, sym40x14, sym64x14, sym80x14, sym128x14,
sym160x14, sym256x14, sym320x14, sym512x14, sym640x14, sym1024x14, sym1280x14, sym2560x14,
sym5120x14, sym6, sym1x12, sym2x12, sym4x12, sym5x12, sym8x12, sym10x12, sym16x12, sym20x12,
sym32x12, sym40x12, sym64x12, sym80x12, sym128x12, sym160x12, sym256x12, sym320x12, sym512x12,
sym640x12, sym1280x12, sym2560x12,
},

| | |
|---|---|
| PeriodicitySet | ENUMERATED {Set1, Set2, Set3, ...} |

}

| | |
|---|---|
| ConfiguredGrantConfig ::= | SEQUENCE { |

...

| | |
|---|---|
| periodicity | ENUMERATED {sym2, sym7, sym1x14, sym2x14, sym4x14, sym5x14, |

sym8x14, sym10x14, sym16x14, sym20x14, sym32x14, sym40x14, sym64x14, sym80x14, sym128x14,
sym160x14, sym256x14, sym320x14, sym512x14, sym640x14, sym1024x14, sym1280x14, sym2560x14,
sym5120x14, sym6, sym1x12, sym2x12, sym4x12, sym5x12, sym8x12, sym10x12, sym16x12, sym20x12,
sym32x12, sym40x12, sym64x12, sym80x12, sym128x12, sym160x12, sym256x12, sym320x12, sym512x12,
sym640x12, sym1280x12, sym2560x12,
},

| | |
|---|---|
| Periodicity-r18 | ENUMERATED {sym16x14, sym17x14, sym18x14, ...} |
| OffsetSet | ENUMERATED {Set1, Set2, Set3} |

}
Note:
the parameter with underline is the first information

In the first example in Table 5, the first information is PeriodicitySet in SPS-config, when PeriodicitySet is configured, the periodicity is not configured. In the second example in Table 5, the first information is Periodicity-r18 and OffsetSet in SPS-config. If Periodicity-r18 and OffsetSet are configured, the periodicity is not configured. In the third example in Table 5, the first information is PeriodicitySet in ConfiguredGrantConfig, when PeriodicitySet is configured, the periodicity is not configured. In the fourth example in Table 5, the first information is Periodicity-r18 and OffsetSet in ConfiguredGrantConfig. If Periodicity-r18 and OffsetSet are configured, the periodicity is not configured.

In some implementations, if the first information is configured, the periodicity parameter periodicity in RRC signaling in TS 38.331 V17.0.0 may not be ignored.

TABLE 6
Example for DL SPS or UL CG:

| | |
|---|---|
| SPS-Config ::= | SEQUENCE { |
| periodicity | ENUMERATED {ms10, ms16, ms17, ms18, ms20, ms32, ms40, ms64, |

ms80, ms128, ms160, ms320, ms640, spare6, spare5, spare4, spare3, spare2, spare1},

| | |
|---|---|
| OffsetSet | ENUMERATED {Set1, Set2, Set3} |

}

| | |
|---|---|
| ConfiguredGrantConfig ::= | SEQUENCE { |
| periodicity | ENUMERATED {sym2, sym7, sym1x14, sym2x14, sym4x14, |

sym5x14, sym8x14, sym10x14, sym16x14, sym20x14, sym32x14, sym40x14, sym64x14, sym80x14,
sym128x14, sym160x14, sym256x14, sym320x14, sym512x14, sym640x14, sym1024x14, sym1280x14,
sym2560x14, sym5120x14, sym6, sym1x12, sym2x12, sym4x12, sym5x12, sym8x12, sym10x12, sym16x12,
sym20x12, sym32x12, sym40x12, sym64x12, sym80x12, sym128x12, sym160x12, sym256x12, sym320x12,
sym512x12, sym640x12, sym1280x12, sym2560x12,
},

| | |
|---|---|
| OffsetSet | ENUMERATED {Set1, Set2, Set3} |

}
Note:
the parameter with underline is the first information

In this example, parameter periodicity and offsetSet are both configured and jointly used for the SPS configuration.

In some embodiments of the disclosed technology, the first information is in the first signaling, when the first signaling is RRC signaling and DCI signaling.

In some implementations, when N=1, which means that there is one periodicity in the first information, when M=1, which means that there is one offset in the first information, or when N=1 and M=1, which means that there are one periodicity and one offset in the first information, an adjusted value is determined by DCI signaling.

In these cases, the adjusted value is valid in the case that:
(1) The first SPS resource behind the DCI signaling in k0 slots, where k0 is a positive integer.
(2) The SPS resources behind the DCI signaling until the next DCI signaling is received, wherein the first SPS resource is behind the DCI signaling in k0 slots.
k0 is determined by DCI signaling or by RRC signaling.

In this case, the adjusted value includes at least one of the following:

### (1) a Periodicity

When the target periodicity determined by DCI signaling is received by UE, the periodicity of R SPS resources is adjusted as the target periodicity.

### (2) Difference Between the Periodicity Adjusted and Periodicity Previously Configured by RRC Signaling.

When the difference determined by DCI signaling is received by UE, the periodicity of R SPS resources is adjusted as previously configured periodicity plus the difference. In an example, the previously configured periodicity by RRC signaling is 16 ms, and the difference determined by DCI signaling is 1 ms, then the target periodicity is 16+1=17 ms.

### (3) Start Offset

When the start offset determined by DCI signaling is received by UE, the time domain location of corresponding SPS resource in R SPS resources is time domain location of first SPS resource plus the start offset.

In some implementations, when N>1, a periodicity list is in the first information. The number of periodicities in the entry of periodicity list is not larger than the maximum number of periodicities determined by at least UE capability.

In some implementations, the number of periodicities in each entry of periodicity list are different. In this case, DCI signaling determines one of the entries in the periodicity list.

For example, the periodicity list is indicated by PeriodicitySetList, the entry in periodicity list is indicated by PeriodicitySet, maximum number of entries is indicated by maxNrofPset, maximum number of periodicities in each entry is indicated by maxNrofPer.

Table 7 shows one of types of periodicity list.

```
PeriodicitySetList :: = SEQUENCE (SIZE(1...maxNrofPset ) ) OF PeriodicitySet
PeriodicitySet :: == SEQUENCE (SIZE(1...maxNrofPer) ) OF P
P
{
    Periodicity-r18, ENUMERATED {ms16, ms17, ms33, ms34, ms50, ...}
  ...
}
PeriodicitySetList :: = SEQUENCE (SIZE(1...maxNrofPset) ) OF PeriodicitySet
PeriodicitySet :: == SEQUENCE (SIZE(1...maxNrofPer) ) OF P
P
{
    Periodicity-r18, ENUMERATED {sym16x14, sym17x14, sym16x12, sym17x12, sym50x12, sym50x14 ...}
  ...
}
```

In the cases where when N=1 and when N>1 discussed above, DCI signaling determines the adjusted value and/or the entry in the periodicity list when predefined condition is fulfilled.

In some implementations, the predefined condition is RRC signaling is configured, including at least one of: periodicity, frame per second or a high layer parameter. In one example, the periodicity parameter in RRC signaling is configured, the predefined condition is fulfilled. In another example, the frame per second is configured, the predefined condition is fulfilled. In another example, the high layer parameter is configured, the predefined condition is fulfilled. In another example, the frame per second and the high layer parameter are both configured, the predefined condition is fulfilled. In another example, the periodicity and the high layer parameter are both configured, the predefined condition is fulfilled. In another example, the periodicity and the frame per second are both configured, the predefined condition is fulfilled. In another example, the periodicity, the frame per second and the high layer parameter are all configured, the predefined condition is fulfilled.

In some implementations, the DCI signaling is UE-specific DCI. To determine the adjusted value and/or the entry in the periodicity list, at least one of the following fields of DCI is re-interpreted: ‘HARQ Process Number,’ ‘Redundancy version,’ ‘Time domain resource assignment,’ ‘Frequency domain resource assignment,’ ‘Modulation and coding scheme,’ ‘Downlink assignment index,’ ‘TPC command for scheduled PUCCH,’ or ‘VRB-to-PRB mapping.’. In this case, the re-interpreted fields of DCI are set to all ones, or all zeros.

In some implementations, the DCI signaling is group common DCI including one or more first block sets.

The first block set includes one or more first blocks. The first block includes the adjusted value, or the entry of periodicity list.

Each first block is associated with UE, serving cell or serving cell group.

In the cases where the DCI signaling is UE-specific DCI and the DCI signaling is group common DCI including one or more first block set as discussed above, the length of DCI field is determined by UE capability such as, the maximum adjusted values, or the maximum number of entries in periodicity list.

For the method for R SPS resources belonging to one SPS configuration discussed above, the time domain location of the K-th SPS resource in the SPS configuration is determined by a number of slots in a system frame, a number of symbols in a slot, a starting system frame identifier number, a starting slot identifier number in the system frame, a starting symbol identifier number in a slot and a function of periodicity, where the function of periodicity in (Eq.1), (Eq.2) or (Eq.3) can be expressed at least as:

$$\{ \begin{matrix}f ( K , P ) = {\sum }_{i = 0}^{K} {P}_{N} ( mod ( i , N ) ) , K > 0 \\ f ( K , P ) = 0 , K = 0\end{matrix}$$

where N denotes the number of periodicities in the first information,
where the P_{N} can be expressed as N periodicities in the first information, e.g. {P=17, P₂₌₁₇, P₃₌₁₆}, when N=3, or where the P_{N} can be expressed as one periodicity and N offsets. For example, when N=3, P_{N} is {P=17, P₂₌₁₇, P₃₌₁₆} by one periodicity 17 ms and 3 offsets {O₁=0, O₂=0, O₃=−1}. In this case, Δ is zero.

In some implementations, the R SPS resources belong to a plurality of SPS configurations.

In some embodiments of the disclosed technology, the first information includes P SPS configurations {ConfigInfo1, ConfigInfo2, . . . . ConfigInfoP}, wherein the n-th SPS configuration includes Rₙ SPS resources with one periodicity, one offset, as well as one periodicity and one offset, and R₁+ . . . +Rₙ+ . . . +Rₚ=R where n is ranging from 0 to P-1 or ranging from 1 to P.

In some implementations, the offset is associated with a first SPS resource of a first SPS configuration, a previous SPS resource of a previous adjacent SPS configuration, or a later SPS resource of the later adjacent SPS configuration.

In one example, the first information includes the offset, and the periodicity for the SPS configuration. In this case, the first information includes a plurality of SPS-config or a plurality of ConfiguredGrantConfig. Assuming the traffic is 60 fps:
Case 1: when the periodicity parameter is in the first information and the periodicity is set to ms50, and then, the offsets are in the corresponding SPS-config or ConfiguredGrantConfig, whose type includes following types:

The offset is associated with a first SPS resource of a first SPS configuration:
(1) Each configuration has corresponding offset: {ms0, ms17, ms34} or {sym0×14, sym17×14, sym34×14}.
(2) Each configuration except the first configuration has corresponding offset: {ms17, ms34}, or {sym17×14, sym34×14}.
(3) Each configuration except the first configuration has corresponding offset which is associated with the gap of k0 millisecond between the first signaling and the first SPS resource of the first configuration.: {ms k0, ms k0+17, ms k0+34}, {ms k0, ms k0+17, ms k0+2*17}, or {sym k0×14, sym (k0+17)×14, sym (k0+34)×14}, {sym k0×14, sym (k0+17)×14, sym (k0+2*17)×14} where k0 is determined by at least the first signaling.

The offset is associated with a previous/later SPS resource of a previous/later adjacent SPS configuration:
(1) Each configuration has corresponding offset: {ms0, ms17, ms17}/{ms17, ms17, ms0} or {sym0×14, sym17×14, sym17×14}/{sym17×14, sym17×14, sym0×14}.
(2) Each configuration except the first/last configuration has corresponding offset: {ms17, ms17} or {sym17×14, sym17×14}.
(3) Common offset: ms17 or sym17×14.

Table 8 shows one of SPS-config in the first information and the first
information, and one of ConfiguredGrantConfig in the first information.

| | |
|---|---|
| SPSGroup :: = | SEQUENCE{ |
| Periodicity-All | ENUMERATED {ms10, ms20, ms32, ms40, ms50, ms64, ms80, |

ms128, ms160, ms320, ms640, spare6, spare5, spare4, spare3, spare2, spare1},
(SIZE(1...maxNroConfig) ) OF SPS-config
}

| | |
|---|---|
| SPS-Config ::= | SEQUENCE { |
| periodicity | ENUMERATED {ms10, ms20, ms32, ms40, ms50, ms64, ms80, ms128, |

ms160, ms320, ms640, spare6, spare5, spare4, spare3, spare2, spare1},

| | |
|---|---|
| Offset | ENUMERATED {ms17, Set1, Set2, Set3} |

}

| | |
|---|---|
| SPSGroup :: = | SEQUENCE { |
| Periodicity-All | ENUMERATED {sym10x14, sym20x14,... spare6, spare5, spare4, |

spare3, spare2, spare1},
(SIZE(1...maxNroConfig) ) OF ConfiguredGrantConfig
}

| | |
|---|---|
| ConfiguredGrantConfig ::= | SEQUENCE { |
| periodicity | ENUMERATED {sym10x14, sym20x14,..., spare6, spare5, spare4, |

spare3, spare2, spare1},

| | |
|---|---|
| Offset | ENUMERATED {sym17x14, Set1, Set2, Set3} |

}
Note:
the periodicity parameter is disable, because the parameter Periodicity-All in the first information is configured.

Case 2: When periodicities and offsets for different SPS configurations are configured in corresponding SPS-config or ConfiguredGrantConfig, the type is shown as follows: The offset is associated with a first SPS resource of a first SPS configuration:

(1) Each configuration has corresponding periodicity and offset: Periodicity-{ms50, ms50, ms50},offset-{ms0, ms17, ms34} or Periodicity-{sym50×14, sym50×14, sym50×14}, offset-{sym0×14, sym17×14, sym34×14}.

(2) Each configuration except the first configuration has corresponding offset, while each configuration has corresponding periodicity: Periodicity-{ms50, ms50, ms50}, offset {ms17, ms34}, or Periodicity-{sym50×14, sym50×14, sym50×14}, offset-{sym17×14, sym34×14}.

The offset is associated with a previous/later SPS resource of a previous/later adjacent SPS configuration:
(1) Each configuration has corresponding periodicity and offset: periodicity-{ms50, ms50, ms50}, offset-{ms0, ms17, ms17}/{ms17,ms17,ms0} or Periodicity-{sym50×14, sym50×14, sym50×14}, offset-{sym0×14, sym17×14, sym17×14}/{sym17×14, sym17×14, sym0×14,}.
(2) Each configuration except the first/last configuration has corresponding offset, while each configuration has corresponding periodicity: Periodicity-{ms50, ms50, ms50}, {ms17, ms17} or Periodicity-{sym50×14, sym50×14, sym50×14}, offset-{sym17×14, sym17×14}.

Table 9 shows the corresponding SPS-config or ConfiguredGrantConfig.

PeriodicityGroup :: == SEQUENCE (SIZE(1...maxNrofConfig) ) OF SPS-config
SPS-config
{

| | |
|---|---|
| Periodicity, | ENUMERATED {ms16, ms17, ms33, ms34, ms50, ...} |
| Offset-r18, | ENUMERATED {ms0, ms16, ms17, ms33, ms34, ...} |

...
}
PeriodicityGroup :: == SEQUENCE (SIZE(1...maxNrofConfig) ) OF ConfiguredGrantConfig
ConfiguredGrantConfig
{

| | |
|---|---|
| Periodicity, | ENUMERATED {sym16x14, sym17x14, sym33x14, sym34x14, sym50x14, ...} |
| Offset-r18, | ENUMERATED {sym0x14, sym16x14, sym17x14, sym33x14, sym34x14, sym50x14, ...} |

...
}

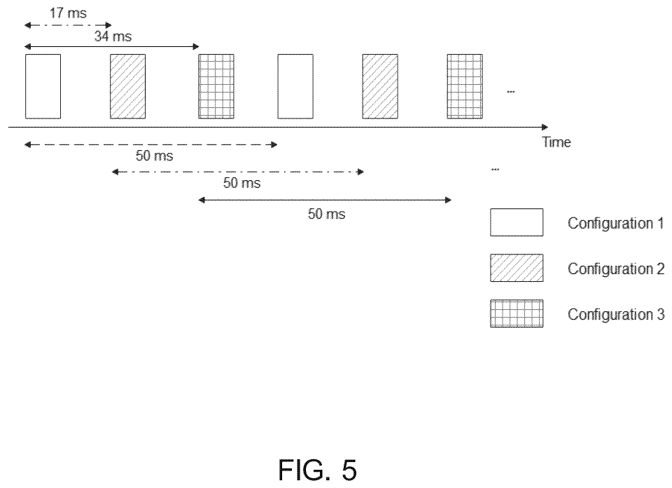

FIG. 5 shows 3 configurations used for configuring SPS resources carrying traffic with 60 FPS periodicity based on some embodiments of the disclosed technology.

In this example, assuming the periodicity of traffic is 60 FPS and the packet arrives in each 16.66 . . . ms, three configurations are set to: (1) SPS-config1: Periodicity=ms50, Offset=ms0; (2) SPS-config2: Periodicity=ms50, Offset-r18=ms17; (3) SPS-config3: Periodicity=ms50, Offset-r18=ms34.

In this example, the starting offset is associated with a first SPS resource of a first SPS configuration, and it can be observed that, out of 6 SPS resources illustrated in FIG. 5, 2 SPS resources are for the first SPS configuration, 2 SPS resources are for the second SPS configuration, and 2 SPS resources are for the third SPS configuration.

In some embodiments of the disclosed technology, the SPS configurations are in the first information in the first signaling, when the first signaling is RRC signaling.

In some implementations, if the periodicity parameter in the first information is configured, the periodicity parameter periodicity in RRC signaling in TS38.331 V17.0.0 is not configured.

In some implementations, if the first information is configured, the periodicity parameter periodicity in RRC signaling in TS38.331 V17.0.0 may not be ignored.

In some embodiments of the disclosed technology, the SPS configurations are in the first information in the first signaling, when the first signaling is RRC signaling and DCI signaling.

In some implementations, an SPS list is in RRC signaling. The number of entries in the SPS list is not larger than the maximum number of entries determined by at least UE capability.

In some implementations, the number of SPS configurations in the entries of the SPS list may vary.

For example, the SPS list is indicated by SPSgroupList, the entry is indicated by ConfigInfo, maximum number of the entries is indicated by maxNrofGroup, maximum number of SPS configurations in one entry is indicated by maxNrofConfig.

Table shows the SPS list for downlink or SPS list for uplink.

SPSgroupList :: = SEQUENCE (SIZE(1...maxNrofGroup) ) OF SPSgroup
SPSgroup:: SEQUENCE (SIZE(1...maxNrofConfig) ) OF SPS-config
SPS-config ==
{

| | |
|---|---|
| P1, | ENUMERATED {ms16, ms17, ms33, ms34, ms50, ...} |
| O1, | ENUMERATED {ms0, ms16, ms17, ms33, ms34, ...} |

...
}
SPSgroupList :: = SEQUENCE(SIZE(1...maxNrofGroup) ) OF SPSgroup
SPSgroup:: == SEQUENCE(SIZE(1...maxNrofConfig) ) OF SPS-config
SPS-config
{

| | |
|---|---|
| P1, | ENUMERATED {sym16x14, sym17x14, sym16x12, sym17x12, sym50x14, ...} |
| O1, | ENUMERATED {sym0x14, sym16x14, sym17x14, sym16x12, sym17x12, ...} |

...
}

In the case where the SPS list is in RRC signaling, DCI signaling determines one of the entries when predefined condition is fulfilled.

In this case, the predefined condition is RRC signaling is configured, including at least one of: periodicity, frame per second and/or a high layer parameter. In one example, the periodicity parameter in RRC signaling is configured, the predefined condition is fulfilled. In another example, the frame per second is configured, the predefined condition is fulfilled. In another example, the high layer parameter is configured, the predefined condition is fulfilled. In another example, the frame per second and the high layer parameter are both configured, the predefined condition is fulfilled. In another example, the periodicity and the high layer parameter are both configured, the predefined condition is fulfilled. In another example, the periodicity and the frame per second are both configured, the predefined condition is fulfilled. In another example, the periodicity, the frame per second and the high layer parameter are all configured, the predefined condition is fulfilled.

In some implementations, the DCI signaling is UE-specific DCI. For determining the one of the entries in SPS list, at least one of the following fields of DCI is re-interpreted: ‘HARQ Process Number’ ‘Redundancy version’, ‘Time domain resource assignment’, ‘Frequency domain resource assignment’, ‘Modulation and coding scheme’, ‘Downlink assignment index’, ‘TPC command for scheduled PUCCH’, or ‘VRB-to-PRB mapping’. In this case, the re-interpreted fields of DCI are set to all ones, or all zeros.

In some implementations, the DCI signaling is group common DCI including one or more first block set.

The first block set includes one or more first blocks. The first block determines the one of entries in SPS list.

Each first block is associated with UE, serving cell or serving cell group.

In the cases where the DCI signaling is UE-specific DCI and the DCI signaling is group common DCI including one or more first block set, the length of DCI field is determined by at least one of: the maximum number of configuration information or the maximum entries of SPS list.

For the method for R SPS resources belonging to one SPS configuration discussed above, the offset information is determined by at least one of: an offset in each SPS configuration in one of entries in the SPS list {[P1, O1], [P2, O2], . . . , [PN, ON]} or an offset determined by DCI signaling. In this case, the time domain location of the K-th SPS resource in the SPS configuration is determined by a number of slots in a system frame, a number of symbols in a slot, a starting system frame identifier number, a starting slot identifier number in the system frame, a starting symbol identifier number in a slot, a function of periodicity, and an offset information.

$$Δ = \{ \begin{matrix}{O}_{0} , & if mod ( K , N ) = 0 \\ {O}_{1} , & if mod ( K , N ) = 1 \\ ⋮ & \\ {O}_{N - 1} , & if mod ( K , N ) = N - 1\end{matrix}$$

while the function f(*) can be expressed at least as:

$$f ( K , P ) = \{ \begin{matrix}floor ( K / N ) \times {P}_{0} , & if mod ( K , N ) = 0 \\ floor ( K / N ) \times {P}_{1} , & if mod ( K , N ) = 1 \\ ⋮ & \\ floor ( K / N ) \times {P}_{N - 1} , & if mod ( K , N = N - 1 )\end{matrix}$$

### Formula Method for Alignment

In some embodiments of the disclosed technology, the first information is a non-integer periodicity determined by the first signaling, including at least one of: periodicity, frame per second, or the high layer parameter, as discussed in the section “Interpretation of a first signaling” above (e.g., the implementations where the periodicity is a float in millisecond or symbol or slot, and the implementations where the periodicity is a fraction in millisecond, symbol or slot).

In some embodiments of the disclosed technology, the non-integer periodicity is in the parameter periodicity in the RRC signaling SPS-config or ConfiguredGrantConfig in TS38.331 V17.0.0.

In some implementations, the value of non-integer periodicity is round down/up with F decimal remaining.

Example 1: if the downlink traffic periodicity is 60 fps, implying the packet arrival per 16.66 . . . ms, the periodicity is set to ms16.66/16.67, wherein 2 decimals remains.

Example 2: if the uplink traffic periodicity is 60 fps, implying the packet arrival per 16.66 . . . ms, the periodicity is set to sym16.66×14 or sym16.67×14, wherein 2 decimals remains.

In some implementations, the value of non-integer periodicity is a fraction.

In some implementations, the numerator of the fraction is frame per second, such as 30 fps, 60 fps, 90 fps, 120 fps, while the denominator of the fraction is at least a time range, such as 1000 ms, 2000 ms, etc.

In some embodiments of the disclosed technology, the non-integer periodicity is expressed by a fraction A/B.

For example, if periodicity of traffic is FPS=60 fps, implying that packet arrives per 16.66 . . . ms.

$$\begin{matrix}periodicity = \frac{1}{FPS} = 0.016666 ... . ( second ) \\ periodicity = \frac{1000}{FPS} = 16.6666 ... . ( millisecond )\end{matrix}$$

As a result, the non-integer periodicity can be expressed as a fraction (e.g., A=1000/B=60).

Here, A is ‘high layer parameter’ and B is ‘frame per second,’ A and B are configured simultaneously to express non-integer periodicity (e.g., 1000/60).

In this case, the parameter A can be both implicit and explicit.

Implicit configuration indicates that A is 1000 without configuration, because 1000 is the default value in the FPS to periodicity in millisecond conversion process, and explicit configuration indicates that A is configured by high layer parameter, such as time range. In other word, a non-integer periodicity can be configured by joint ‘high layer parameter’ and ‘frame per second,’ or a non-integer periodicity can be configured by only ‘frame per second.’

In some implementations, the non-integer periodicity is in the first information in the RRC signaling SPS-config or ConfiguredGrantConfig.

In some implementations, if the first information is configured, the periodicity parameter periodicity in RRC signaling in TS38.331 V17.0.0 is not configured.

In some embodiments of the disclosed technology, if the first information is configured, the periodicity parameter periodicity in RRC signaling in TS38.331 V17.0.0 may not be ignored.

In an example, for uplink traffic with periodicity is 60 fps, implying the packet arrival per 16.66 . . . ms, the first parameter is configured to ms16.66/ms16.67, and the parameter in RRC signaling in TS38.331 V17.0.0 is configured to sym14. The parameter P in equations Eq.2 and Eq.3 is the multiplexing results of the first parameter and parameter in RRC signaling in TS38.331 V17.0.0.

In some embodiments of the disclosed technology, with non-integer periodicity determined by RRC signaling, the alignment is in equations Eq. 1, Eq. 2 and Eq. 3. In one example, the time domain location of the K-th SPS resource in the SPS configuration is determined by a number of slots in a system frame, a number of symbols in a slot, a starting system frame identifier number, a starting slot identifier number in the system frame, a starting symbol identifier number in a slot and a function of periodicity. When non-integer periodicity is configured in RRC signaling SPS-config or ConfiguredGrantConfig, the function of periodicity is at least one of the following: (1) Floor operation; (2) Round operation; (3) Ceiling operation.

In an example, assuming the traffic periodicity is 60 fps, and P is configured to ms16.67 by RRC signaling for downlink transmission. The time domain location of the K-th SPS resource is expressed as at least:

$${N}_{slot}^{frame} \times {L}_{SFN} + {L}_{slot} = [ ( {N}_{slot}^{frame} \times {S}_{SFN , Start} + {S}_{slot , start} ) + ceil ( K \times P ) \times {N}_{slot}^{frame} / 10 ] modulo ( 1024 \times {N}_{slot}^{frame} )$$

assuming the traffic periodicity is 60 fps, and P is configured to sym16.67×14 by RRC signaling for uplink transmission. The time domain location of the K-th SPS resource is expressed as at least one of:

$$\begin{matrix}[ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN} \times {N}_{slot}^{frame} \times {N}_{symbol}^{slot} + {Δ}_{offset} \times {N}_{symbol}^{slot} + S + ceil ( K \times P ) ] modulo ( 1024 \times {N}_{slot}^{frame} \times {N}_{symbol}^{slot} ) \\ [ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN , start} \times {N}_{slot}^{frame} \times {N}_{symbol}^{slot} + {S}_{slot , start} \times {N}_{symbol}^{slot} + {S}_{symbol , start} + ceil ( K \times P ) ] \cdot modulo ( 1024 \times {N}_{slot}^{frame} \times {N}_{symbol}^{slot} )\end{matrix}$$

or

In another example, the time domain location of the K-th SPS resource in the SPS configuration is determined by a number of slots in a system frame, a number of symbols in a slot, a starting system frame identifier number, a starting slot identifier number in the system frame, a starting symbol identifier number in a slot and a function of periodicity. Assuming the traffic periodicity is 60 fps, and the periodicity is fps60 configured by the first information in RRC signaling for downlink transmission. The time domain location of the K-th SPS resource is expressed as at least:

$${N}_{slot}^{frame} \times {L}_{SFN} + {L}_{slot} = [ ( {N}_{slot}^{frame} \times {S}_{SFN , Start} + {S}_{slot , start} ) + ceil ( K \times 1000 / FPS ) \times {N}_{slot}^{frame} / 10 ] modulo ( 1024 \times {N}_{slot}^{frame} )$$

wherein FPS is the frame per second configured by RRC signaling.

Alternatively for uplink transmission, the time domain location of the K-th SPS resource is expressed as at least one of:

$$\begin{matrix}[ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN} \times {N}_{slot}^{frame} \times {N}_{symbol}^{slot} + {Δ}_{offset} \times {N}_{symbol}^{slot} + S + ceil ( K \times 1000 * 14 ( 12 ) / FPS ) ] modulo ( 1024 \times {N}_{slot}^{frame} \times {N}_{symbol}^{slot} ) \\ or , \\ [ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN , start} \times {N}_{slot}^{frame} \times {N}_{symbol}^{slot} + {S}_{slot , start} \times {N}_{symbol}^{slot} + {S}_{symbol , start} + ceil ( K \times 1000 * 14 ( 12 ) / FPS ) ] modulo ( 1024 \times {N}_{slot}^{frame} \times {N}_{symbol}^{slot} )\end{matrix}$$

where 14(12) indicates that the value is either 14 or 12.

In another example, the time domain location of the K-th SPS resource in the SPS configuration is determined by a number of slots in a system frame, a number of symbols in a slot, a starting system frame identifier number, a starting slot identifier number in the system frame, a starting symbol identifier number in a slot, a function of periodicity and a high layer parameter. Assuming the traffic periodicity is 60 fps, and the periodicity is fps60 and time range ms 1000 both configured by the first information in RRC signaling for downlink transmission. The time domain location of the K-th SPS resource is expressed as at least:

$${N}_{slot}^{frame} \times {L}_{SFN} + {L}_{slot} = [ ( {N}_{slot}^{frame} \times {S}_{SFN , Start} + {S}_{slot , start} ) + ceil ( K \times T / FPS ) \times {N}_{slot}^{frame} / 10 ] modulo ( 1024 \times {N}_{slot}^{frame} )$$

or for uplink transmission, the time domain location of the K-th SPS resource is expressed as at least one of:

$$\begin{matrix}[ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN} \times {N}_{slot}^{frame} \times {N}_{symbol}^{slot} + {Δ}_{offset} \times {N}_{symbol}^{slot} + S + ceil ( K \times T * 14 ( 12 ) / FPS ) ] modulo ( 1024 \times {N}_{slot}^{frame} \times {N}_{symbol}^{slot} ) \\ [ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN , start} \times {N}_{slot}^{frame} \times {N}_{symbol}^{slot} + {Δ}_{offset} \times {N}_{symbol}^{slot} + S + ceil ( K \times T * 14 ( 12 ) / FPS ) ] modulo ( 1024 \times {N}_{slot}^{frame} \times {N}_{symbol}^{slot} )\end{matrix}$$

where 14(12) means that the value is either 14 or 12, and wherein FPS is the frame per second and T is time range, both configured by RRC signaling.

In some embodiments of the disclosed technology, with non-integer periodicity determined by RRC signaling, the time domain location of the K-th SPS resource in the SPS configuration is determined by a number of slots in a system frame, a number of symbols in a slot, a starting system frame identifier number, a starting slot identifier number in the system frame, a starting symbol identifier number in a slot, a function of periodicity.

In some implementations, when non-integer periodicity is configured in RRC signaling SPS-config or ConfiguredGrantConfig, the function of periodicity is at least one of the following: Step function with a threshold TH

In an example, assuming the traffic periodicity is 60 fps, and P is configured to ms16.67 by RRC signaling for downlink transmission. The time domain location of the K-th SPS resource is express at least as:

$${N}_{slot}^{frame} \times {L}_{SFN} + {L}_{slot} = \{ \begin{matrix}[ ( {N}_{slot}^{frame} \times {S}_{SFN , Start} + {S}_{slot , start} ) + ceil ( K \times P ) \times {N}_{slot}^{frame} / 10 ] modulo ( 1024 \times {N}_{slot}^{frame} ) , if condition 1 \\ [ ( {N}_{slot}^{frame} \times {S}_{SFN , Start} + {S}_{slot , start} ) + floor ( K \times P ) \times {N}_{slot}^{frame} / 10 ] modulo ( 1024 \times {N}_{slot}^{frame} ) , otherwise\end{matrix}$$

Alternatively, for uplink transmission, P is configured to sym16.67×14 or sym16.67×12. The time domain location of the K-th SPS resource is express as at least one of:

$$\begin{matrix}[ ( {L}_{SFN} \times {N}_{slot}^{frame} \times {N}_{frame}^{slot} ) + ( {L}_{slot} \times {N}_{symbol}^{slot} ) + {L}_{symbol} ] = \{ \begin{matrix}[ ( {S}_{SFN} \times {N}_{slot}^{frame} \times {N}_{frame}^{slot} + {Δ}_{offset} + {N}_{symbol}^{slot} + S + ceil ( K \times P ) ] modulo ( 1024 \times {N}_{slot}^{frame} \times {N}_{frame}^{slot} ) , if condition 1 \\ [ ( {S}_{SFN} \times {N}_{slot}^{frame} \times {N}_{frame}^{slot} + {Δ}_{offset} + {N}_{symbol}^{slot} + S + floor ( K \times P ) ] modulo ( 1024 \times {N}_{slot}^{frame} \times {N}_{frame}^{slot} ) , otherwise\end{matrix} \\ or , \\ [ ( {L}_{SFN} \times {N}_{slot}^{frame} \times {N}_{frame}^{slot} ) + ( {L}_{slot} \times {N}_{symbol}^{slot} ) + {L}_{symbol} ] = \{ \begin{matrix}[ ( {S}_{SFN} \times {N}_{slot}^{frame} \times {N}_{frame}^{slot} + {Δ}_{offset} + {N}_{symbol}^{slot} + S + ceil ( K \times P ) ] modulo ( 1024 \times {N}_{slot}^{frame} \times {N}_{frame}^{slot} ) , if condition 1 \\ [ ( {S}_{SFN} \times {N}_{slot}^{frame} \times {N}_{frame}^{slot} + {Δ}_{offset} + {N}_{symbol}^{slot} + S + floor ( K \times P ) ] modulo ( 1024 \times {N}_{slot}^{frame} \times {N}_{frame}^{slot} ) , otherwise\end{matrix}\end{matrix}$$

wherein condition1 is expressed as

$$K \times P - floor ( {K}^{*} P ) \leq TH .$$

In some implementations, the threshold parameter TH is based on a number of remaining decimals, and configured by at least one of: (1) RRC signaling; (2) MAC CE; (3) DCI signaling.

In some embodiments of the disclosed technology, with high layer parameter determined by RRC signaling, the time domain location of the K-th SPS resource in the SPS configuration is determined by a number of slots in a system frame, a number of symbols in a slot, a starting system frame identifier number, a starting slot identifier number in the system frame, a starting symbol identifier number in a slot, an offset information, a function of periodicity and a high layer parameter.

In this way, some embodiments of the disclosed technology can prevent the configuration from being out of a system frame.

The legacy formula (downlink for example) can be interpreted as follows:

$$( numberOfSlotsPerFrame \times SFN + slot number in the the frame ) = [ ( numberOfSlotsPerFrame \times {SFN}_{start time} + {slot}_{start time} ) + N \times periodicity \times numberOfSlotsPerFrame / 10 ] modulo ( 1024 \times numberOfSlotsPerFrame ) .$$

The goal of this formula is to find out the slot location of each SPS resource.

Here, it is assumed that: numberOfSlotsPerFrame=10; SFN_{start,time}=0; Slot_{start,time}=0. In some implementations, the above three parameters are determined by the system.

In one example, if the periodicity parameter is set to ms10, the slot location of N-th (N>0) SPS resource is shown as follows:

(1) The first SPS resource location (N=0): Slot location=[(numberOfSlotsPerFrame×SFN_{start time}+slot_{start time})+N×periodicity×numberOfSlotsPerFrame/10] modulo (1024×numberOfSlotsPerFrame)=(0+0×10×1) modulo (1024×10)=0. The first SPS location is in the first slot.

(2) The second SPS resource location (N=1): Slot location=[(numberOfSlotsPerFrame×SFN_{start time}+slot_{start time})+N×periodicity×numberOfSlotsPerFrame/10] modulo (1024×numberOfSlotsPerFrame)=(0+1×10×1) modulo (1024×10)=10. The second SPS location is in the 11-th slot.

(3) The third SPS resource location (N=2): Slot location=[(numberOfSlotsPerFrame×SFN_{start time}+slot_{start time})+N×periodicity×numberOfSlotsPerFrame/10] modulo (1024×numberOfSlotsPerFrame)=(0+2×10×1) modulo (1024×10)=20. The third SPS location is in the 21-th slot.

In this way, the periodical SPS resources are configured.

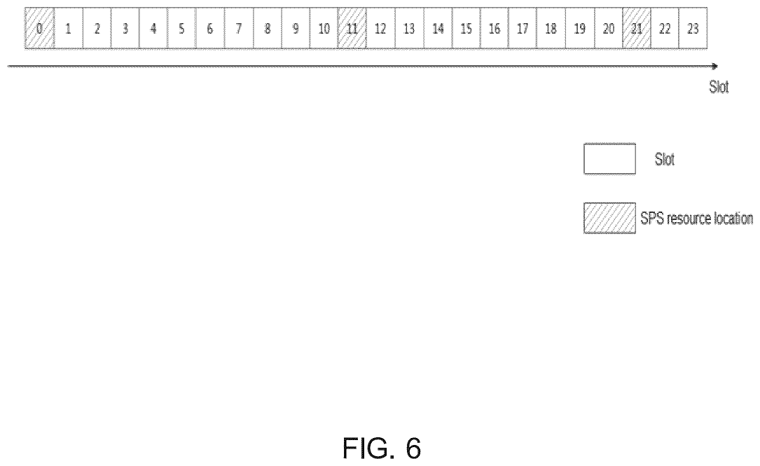

FIG. 6 shows an example of SPS resource locations based on some embodiments of the disclosed technology.

SFN_{start,time}, Slot_{start,time} may affect the location of the first SPS resource. In other words, these two parameters can control an offset of SPS configuration. In addition, the number in the bracket behind the modulo operation is 1024, which mean that in a super frame, there are 1024 system frames. It can be observed that in a super frame, the location of SPS resources can be periodically derived by the formula. However, when SPS resources cross from one super frame to another super frame, the mismatch problem may occur.

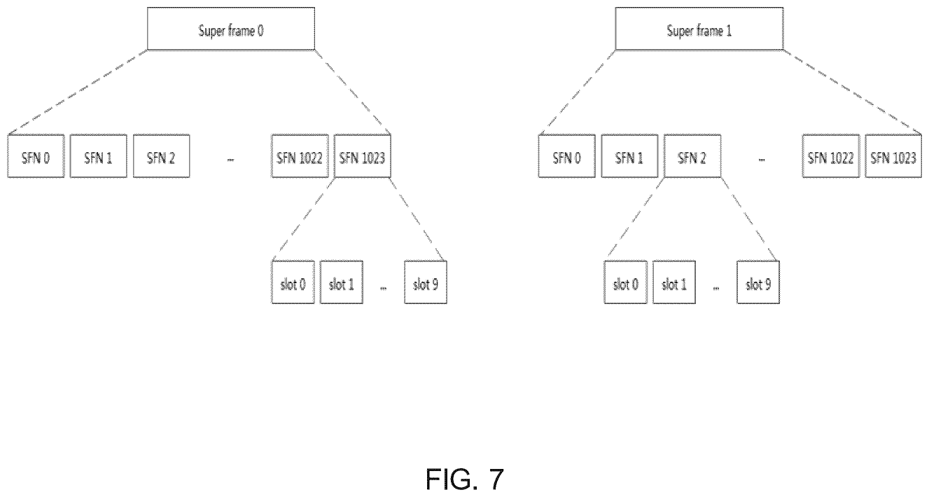

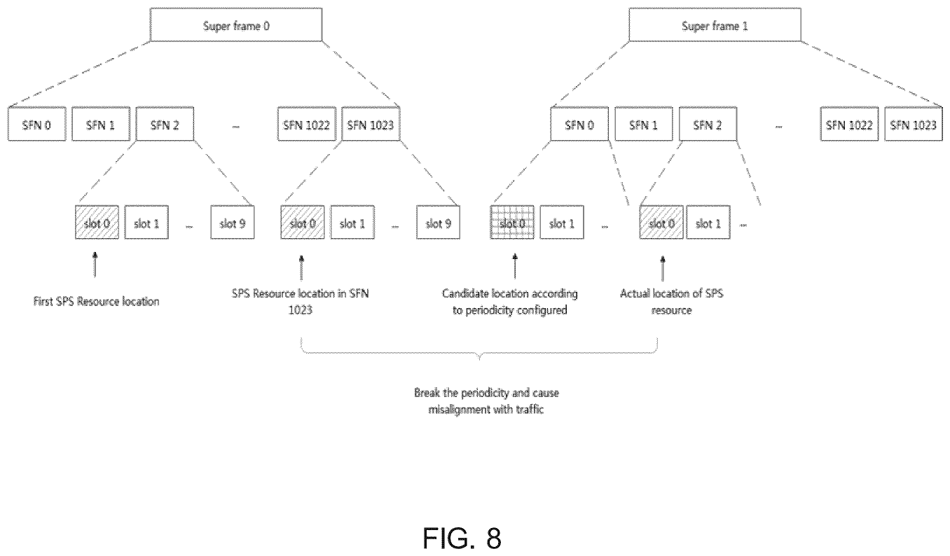

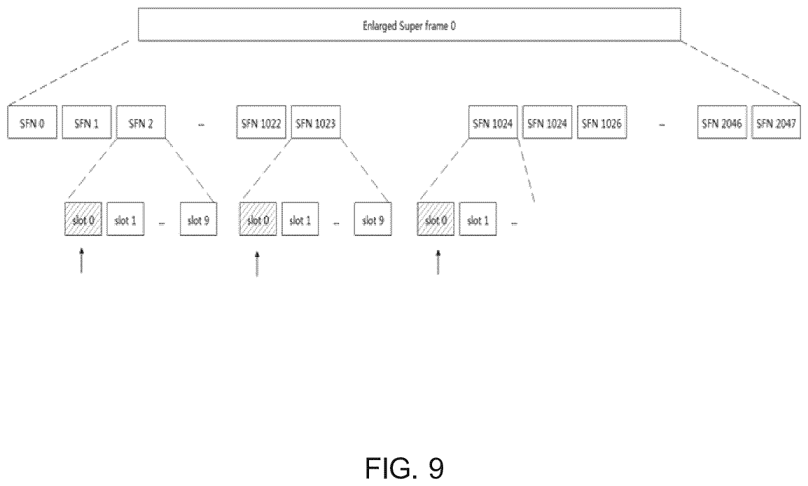

FIG. 7 shows an example of super frame, system frame and slot. FIG. 8 shows another example of super frame, system frame and slot. FIG. 9 shows an example of an enlarged super frame.

Referring to FIG. 7, the structure of a super frame, a system frame and slot are depicted, respectively. Referring to FIG. 8, assuming that the SFN_{start,time} is 2, which means that the SPS resources are configured starting from SFN 2 in super frame 0, and if the slot 0 of SFN 1023 is the last SPS resources in the super frame 0, for the 10 ms periodicity, the next SPS resource may be in slot 0 of SFN 0 in the super frame 1. However, when it comes to another super frame, the SFN_{start,time} would be reset to 2, and the next SPS resource may be configured in SFN 2, which cause a mismatch problem.

In some implementations, the definition of a super frame is enlarged and SFN_{start,time} should be fixed in an enlarged super frame by a high layer parameter, such as time range.

For example, the enlarged super frame may include 2 legacy super frames,

$$( numberOfSlotsPerFrame \times SFN + slot number in the the frame ) = [ ( numberOfSlotsPerFrame \times {SFN}_{start time} + {slot}_{start time} ) + N \times periodicity \times numberOfSlotsPerFrame / 10 ] modulo ( 2048 \times numberOfSlotsPerFrame ) .$$

Alternatively, SFN_{start time} would be determined only when SPS configuration is activation. In this case, the super frame be shortened for aligning the number of SFN in a super frame and the frame per second. In an example, the FPS to periodicity in millisecond conversion process is based on 1000 millisecond or 1 second. As a result, the high layer parameter, time range is set to 1000, in order to align the number of SFN in a super frame and the frame per second.

$$( numberOfSlotsPerFrame \times SFN + slot number in the the frame ) = [ ( numberOfSlotsPerFrame \times {SFN}_{start time} + {slot}_{start time} ) + N \times periodicity \times numberOfSlotsPerFrame / 10 ] modulo ( 1000 \times numberOfSlotsPerFrame )$$

In some implementations, when a high layer parameter is configured by RRC signaling SPS-config or ConfiguredGrantConfig, the values of equations Eq. 1, Eq. 2 or Eq. 3 are determined by the high layer parameter, such as time range.

### Example for Downlink:

$${N}_{slot}^{frame} \times {L}_{SFN} + {L}_{slot} = [ ( {N}_{slot}^{frame} \times {S}_{SFN , Start} + {S}_{slot , start} + Δ ) + f ( K , P ) \times {N}_{slot}^{frame} / 10 ] modulo ( T \times {N}_{slot}^{frame} )$$

### Example for Uplink

$$\begin{matrix}[ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN} \times {N}_{slot}^{frame} \times {N}_{symbol}^{slot} + {Δ}_{offset} \times {N}_{symbol}^{slot} + S + Δ + f ( K , P ) ] modulo ( T \times {N}_{slot}^{frame} \times {N}_{symbol}^{slot} ) \\ or , \\ [ ( {L}_{SFN} \times {N}_{slot}^{frame} \times {N}_{symbol}^{slot} ) + ( {L}_{slot} \times {N}_{symbol}^{slot} ) + {L}_{symbol} ] = [ {S}_{SFN , start} \times {N}_{slot}^{frame} \times {N}_{symbol}^{slot} + {S}_{slot , start} \times {N}_{symbol}^{slot} + {S}_{symbol , start} + Δ + f ( K , P ) ] modulo ( T \times {N}_{slot}^{frame} \times {N}_{symbol}^{slot} )\end{matrix}$$

where T denotes the high layer parameter.

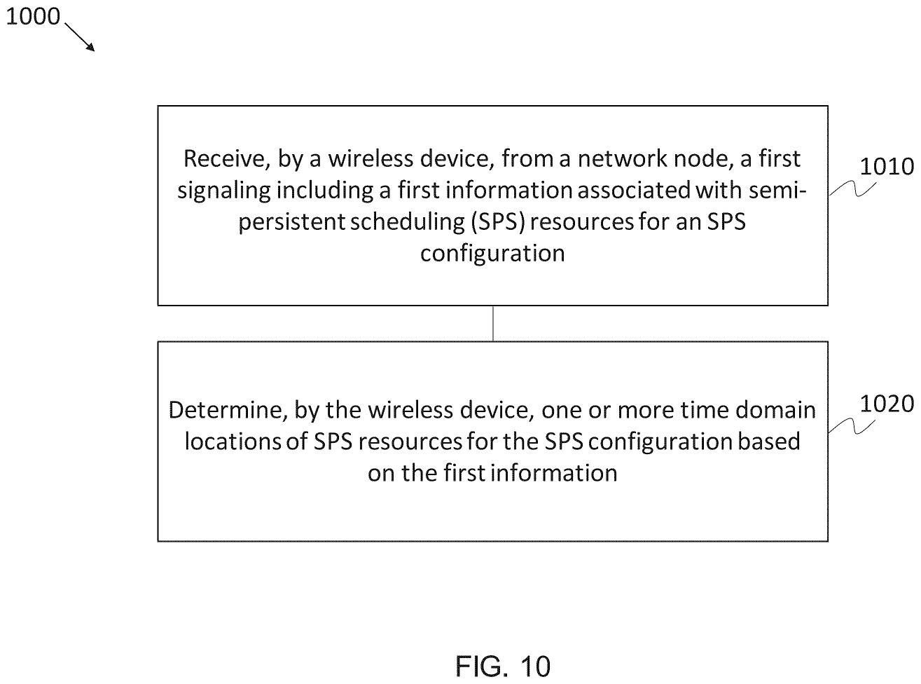

FIG. 10 shows an example of a process for wireless communication based on some example embodiments of the disclosed technology.

In some implementations, the process 1000 for wireless communication may include, at 1010, receiving, by a wireless device, from a network node, a first signaling including a first information associated with semi-persistent scheduling (SPS) resources for an SPS configuration, and at 1020, determining, by the wireless device, one or more time domain locations of SPS resources for the SPS configuration based on the first information.

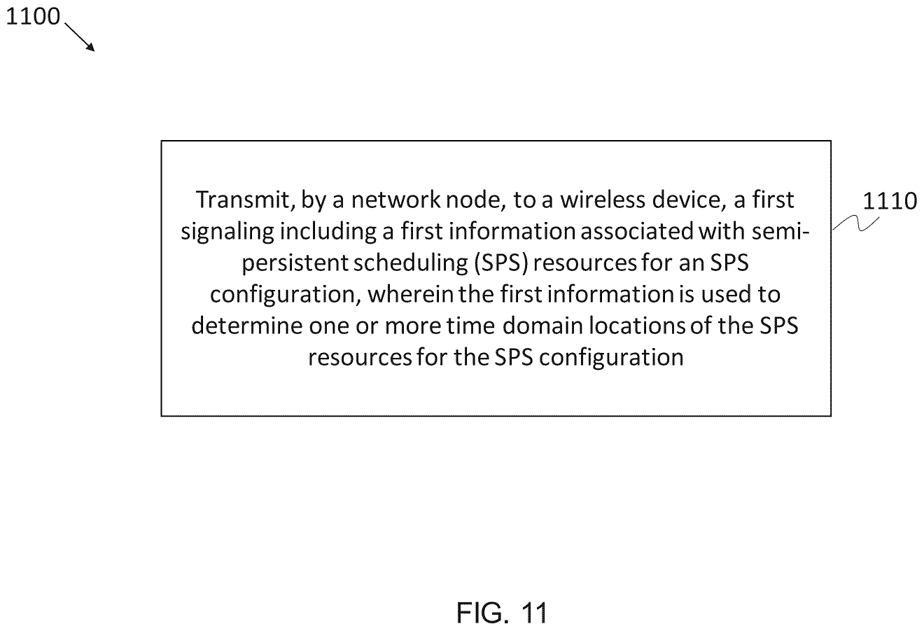

FIG. 11 shows another example of a process for wireless communication based on some example embodiments of the disclosed technology.

In some implementations, the process 1100 for wireless communication may include, at 1110, transmitting, by a network node, to a wireless device, a first signaling including a first information associated with semi-persistent scheduling (SPS) resources for an SPS configuration, wherein the first information is used to determine one or more time domain locations of the SPS resources for the SPS configuration.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: receiving, by a wireless device, from a network node, a first signaling including a first information associated with semi-persistent scheduling (SPS) resources for an SPS configuration; and determining, by the wireless device, one or more time domain locations of SPS resources for the SPS configuration based on the first information.

Clause 2. The method of clause 1, wherein the SPS configuration includes one or more SPS resources.

Clause 3. The method of clause 1, wherein the first information includes at least one of: a number of SPS configurations, one or more SPS configurations, one or more periodicities of SPS resources for one or more SPS configurations, or an offset of one or more SPS resources for one or more SPS configurations, wherein the number of SPS configurations is less than a maximum number of configured SPS configurations, wherein the offset is an integer in millisecond, symbol or slot, where the offset is associated with at least one of: a first SPS resource of a first SPS configuration; a previous SPS resource of a previous adjacent SPS configuration; or a later SPS resource of a later adjacent SPS configuration.

Clause 4. The method of clause 1, wherein the one or more time domain locations include one or more slot locations or symbol locations.

Clause 5. The method of clause 1, wherein the first signaling includes at least one of radio resource control (RRC) signaling, medium access control (MAC) control element (CE) signaling, or downlink control information (DCI) signaling.

Clause 6. The method of clause 5, wherein the DCI signaling is a wireless device specific DCI or a group common DCI, wherein the DCI includes a field associated with the first information, a length of which is determined by an information associated with UE capability, including at least one of: maximum number of periodicities, maximum number of offsets, or maximum number of SPS configurations.

Clause 7. The method of clause 6, wherein the field of DCI includes at least one of: hybrid automatic repeat request (HARQ) process number, redundancy version, time domain resource assignment, frequency domain resource assignment, modulation and coding scheme, downlink assignment index, transmission power control (TPC) command for scheduled physical uplink control channel (PUCCH), or virtual resource block (VRB)-to-physical resource block (PRB) mapping.

Clause 8. The method of clause 3, wherein a periodicity in the first information includes a non-integer value or an integer value of the periodicity that is larger than zero and has a unit of millisecond, symbol or slot.

Clause 9. The method of clause 8, wherein the non-integer value of the periodicity includes a float or a fraction in a unit of millisecond, symbol or slot.

Clause 10. The method of clause 9, wherein a numerator of the fraction includes at least one of: a frame per second (FPS) that indicates a number of frames that appears within a second; a denominator of the fraction includes a high layer parameter.

Clause 11. The method of clause 1, wherein the time domain locations of R SPS resources are determined by the first information, wherein R indicates the amount of SPS resources, and R is a positive integer.

Clause 12. The method of clause 11, wherein the first information includes N periodicities, wherein N is a positive integer.

Clause 13. The method of clause 12, wherein the time domain location of SPS resources is determined by the N periodicities, wherein the N periodicities are cyclically used, or one or more periodicities in the N periodicities are used.

Clause 14. The method of clause 11, wherein the first information includes a periodicity with M offsets, wherein M is a positive integer.

Clause 15. The method of clause 14, wherein the time domain location of the SPS resources is determined by at least one of a periodicity, the M offsets, wherein the M offsets are cyclically used.

Clause 16. The method of clause 11, wherein the first information includes N periodicities, or M offsets, or both the N periodicities and M offsets, wherein N and M are positive integers, wherein in a case that at least one of N or M equals one, an adjustment value is determined by the first signaling.

Clause 17. The method of clause 16, wherein the adjustment value includes at least one of: a periodicity; a difference between a target periodicity and a previous periodicity; or a starting offset associated with a first SPS resource of the first SPS configuration.

Clause 18. The method of clauses 11, wherein the first information includes P SPS configurations, wherein P is a positive integer.

Clause 19. The method of clause 18, wherein the time domain location of Rₙ SPS resources is determined by the n-th SPS configuration in the P SPS configurations, wherein the n is a positive integer which is not less than 0 and not larger than P, wherein P is the number of SPS configurations, wherein R₁+ . . . +Rₙ+ . . . +R_{P}=R, wherein R indicates the amount of SPS resource for the n-th SPS configuration, and Rₙ is a positive integer.

Clause 20. The method of clause 19, wherein the offset of Rₙ(n>1) SPS resources is associated with at least one of: the R₁ SPS resources, the Rₙ₋₁ SPS resources, or the Ron SPS resources.

Clause 21. The method of clause 20, wherein the offset of R SPS resources is associated with at least the first signaling.

Clause 22. The method of clause 11, wherein the first information determines the time domain locations of R SPS resources upon satisfaction of a predefined condition.

Clause 23. The method of clause 22, wherein the predefined condition is satisfied in a case that the RRC signaling is configured to include at least one of periodicity, frame per second or time range.

Clause 24. The method of clause 8, wherein the periodicity in the first information is a non-integer value of periodicity or offset, the time domain location of the K-th SPS resource in the SPS configuration is determined by at least one of: a number of slots in a system frame, a number of symbols in a slot, a starting system frame identifier number, a starting slot identifier number in the system frame, a starting symbol identifier number in a slot, an offset information, a function of periodicity, or a high layer parameter, wherein K is not less than 0.

Clause 25. The method of clause 24, wherein the offset information is determined by at least one of the first information or an adjustment value.

Clause 26. The method of clauses 24, wherein the function of periodicity includes at least one of a ceiling operation, a round operation, or a floor operation.

Clause 27. The method of clause 24, wherein the function of periodicity is a ceiling operation, wherein a formula for time domain location of SPS resource is expressed as:

$${N}_{slot}^{frame} \times {L}_{SFN} + {L}_{slot} = [ ( {N}_{slot}^{frame} \times {S}_{SFN , Start} + {S}_{slot , start} ) + ceil ( K \times Pi ) \times {N}_{slot}^{frame} / 10 ] modulo ( 1024 \times {N}_{slot}^{frame} )$$

wherein Nₛₗₒₜ^{frame} denotes the number of slots in a system frame, L_{SFN} denotes the identifier number V slot of the system frame, Lₛₗₒₜ denotes the identifier number of the slot in the system frame, S_{SFN, Start} denotes the starting system frame identifier number, S denotes the starting slot identifier number in the system frame, and Pi denotes the periodicity configured in RRC signaling.

Clause 28. The method of any of clauses 1-27, wherein the SPS configuration includes at least one of SPS configuration for downlink or configured grant scheduling (CG) configuration for uplink.

Clause 29. The method of any of clauses 1-27, wherein the SPS resources include at least one of SPS PDSCH for downlink or CG PUSCH for uplink.

Clause 30. A method of wireless communication, comprising: transmitting, by a network node, to a wireless device, a first signaling including a first information associated with semi-persistent scheduling (SPS) resources for an SPS configuration, wherein the first information is used to determine one or more time domain locations of the SPS resources for the SPS configuration.

Clause 31. The method of clause 30, wherein the SPS configuration includes at least one of: one or more SPS resources.

Clause 32. The method of clause 30, wherein the first information includes at least one of: a number of SPS configurations, one or more SPS configurations, one or more periodicities of SPS resources for one or more SPS configurations, or an offset of one or more SPS resources for one or more SPS configurations, wherein the number of SPS configurations is less than a maximum number of configured SPS configurations, wherein the offset is an integer in millisecond, symbol or slot, where the offset is associated with at least one of: a first SPS resource of a first SPS configuration; a previous SPS resource of a previous adjacent SPS configuration; or a later SPS resource of a later adjacent SPS configuration.

Clause 33. The method of clause 32, wherein a periodicity in the first information includes a non-integer value or an integer value of the periodicity that is larger than zero and has a unit of millisecond, symbol or slot.

Clause 34. The method of clause 33, wherein the non-integer value of the periodicity includes a float or a fraction in a unit of millisecond, symbol or slot.

Clause 35. The method of clause 34, wherein a numerator of the fraction includes at least one of: a frame per second (FPS) that indicates a number of frames that appears within a second; a denominator of the fraction includes a high layer parameter.

Clause 36. The method of clause 30, wherein the first signaling includes at least one of radio resource control (RRC) signaling, medium access control (MAC) control element (CE) signaling, or downlink control information (DCI) signaling.

Clause 37. The method of clause 33, wherein the DCI signaling is a wireless device specific DCI or a group common DCI, wherein the DCI includes a field associated with the first information, a length of which is determined by an information associated with UE capability, including at least one of: maximum number of periodicities, maximum number of offsets, or maximum number of SPS configurations.

Clause 38. The method of clause 34, wherein the field of DCI includes at least one of: hybrid automatic repeat request (HARQ) process number, redundancy version, time domain resource assignment, frequency domain resource assignment, modulation and coding scheme, downlink assignment index, transmission power control (TPC) command for scheduled physical uplink control channel (PUCCH), or virtual resource block (VRB)-to-physical resource block (PRB) mapping.

Clause 39. An apparatus for wireless communication comprising a processor that is configured to carry out the method of any of clauses 1 to 38.

Clause 40. A non-transitory computer readable medium having code stored thereon, the code when executed by a processor, causing the processor to implement a method recited in any of clauses 1 to 38.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
receiving, by a wireless device, from a network node, a first signaling including a first information associated with semi-persistent scheduling (SPS) resources for an SPS configuration; and
determining, by the wireless device, one or more time domain locations of SPS resources for the SPS configuration based on the first information.

2. The method of claim 1, wherein the SPS configuration includes one or more SPS resources.

3. The method of claim 1, wherein the first information includes at least one of: a number of SPS configurations, one or more SPS configurations, one or more periodicities of SPS resources for one or more SPS configurations, or an offset of one or more SPS resources for one or more SPS configurations, wherein the number of SPS configurations is less than a maximum number of configured SPS configurations, wherein the offset is an integer in millisecond, symbol or slot, where the offset is associated with at least one of: a first SPS resource of a first SPS configuration; a previous SPS resource of a previous adjacent SPS configuration; or a later SPS resource of a later adjacent SPS configuration.

4. The method of claim 1, wherein the one or more time domain locations include one or more slot locations or symbol locations.

5. The method of claim 1, wherein the first signaling includes at least one of radio resource control (RRC) signaling, medium access control (MAC) control element (CE) signaling, or downlink control information (DCI) signaling.

6. The method of claim 5, wherein the DCI signaling is a wireless device specific DCI or a group common DCI, wherein the DCI includes a field associated with the first information, a length of which is determined by an information associated with UE capability, including at least one of: maximum number of periodicities, maximum number of offsets, or maximum number of SPS configurations.

7. The method of claim 6, wherein the field of DCI includes at least one of: hybrid automatic repeat request (HARQ) process number, redundancy version, time domain resource assignment, frequency domain resource assignment, modulation and coding scheme, downlink assignment index, transmission power control (TPC) command for scheduled physical uplink control channel (PUCCH), or virtual resource block (VRB)-to-physical resource block (PRB) mapping.

8. The method of claim 3, wherein a periodicity in the first information includes a non-integer value or an integer value of the periodicity that is larger than zero and has a unit of millisecond, symbol or slot.

9. The method of claim 8, wherein the non-integer value of the periodicity includes a float or a fraction in a unit of millisecond, symbol or slot.

10. The method of claim 9, wherein a numerator of the fraction includes at least one of: a frame per second (FPS) that indicates a number of frames that appears within a second; a denominator of the fraction includes a high layer parameter.

11. The method of claim 1, wherein the time domain locations of R SPS resources are determined by the first information, wherein R indicates the amount of SPS resources, and R is a positive integer.

12. The method of claim 11, wherein the first information includes N periodicities, wherein N is a positive integer.

13. The method of claim 12, wherein the time domain locations of SPS resources are determined by the N periodicities, wherein the N periodicities are cyclically used, or one or more periodicities in the N periodicities are used.

14. The method of claim 11, wherein the first information includes a periodicity with M offsets, wherein M is a positive integer.

15. The method of claim 14, wherein the time domain locations of the SPS resources are determined by at least one of a periodicity, the M offsets, wherein the M offsets are cyclically used.

16. The method of claim 11, wherein the first information includes N periodicities, or M offsets, or both the N periodicities and M offsets, wherein N and M are positive integers, wherein in a case that at least one of N or M equals one, an adjustment value is determined by the first signaling.

17. The method of claim 16, wherein the adjustment value includes at least one of: a periodicity; a difference between a target periodicity and a previous periodicity; or a starting offset associated with a first SPS resource of the first SPS configuration.

18. The method of claim 11, wherein the first information includes P SPS configurations, wherein P is a positive integer.

19-29. (canceled)

30. A method of wireless communication, comprising:
transmitting, by a network node, to a wireless device, a first signaling including a first information associated with semi-persistent scheduling (SPS) resources for an SPS configuration, wherein the first information is used to determine one or more time domain locations of the SPS resources for the SPS configuration.

31-39. (canceled)

40. A non-transitory computer readable medium having code stored thereon, the code when executed by a processor, causing the processor to implement a method recited in claim 1.
